(19) United States
(12) Patent Application Publication
(10) Pub. No.: US 2013/0108883 A1
(43) Pub. Date: May 2, 2013

(54) THERMOPLASTIC POLYMER COMPOSITIONS WITH PROGRAMMABLE END-OF-LIFE AND METHOD OF MAKING THE SAME

(71) Applicant: EATON CORPORATION, Cleveland, OH (US)

(72) Inventors: Arjun Krishnan, Chandler, AZ (US); Joe Lowry, Pinehurst, NC (US)

(73) Assignee: EATON CORPORATION, Cleveland, OH (US)

(21) Appl. No.: 13/664,060

(22) Filed: Oct. 30, 2012

Related U.S. Application Data
(60) Provisional application No. 61/553,908, filed on Oct. 31, 2011.

(51) Int. Cl. C08L 53/00; B32B 27/24

(52) U.S. Cl. CPC C08L 53/00; B32B 27/24
USPC 428/521; 524/505; 524/323; 428/523; 428/522

(57) ABSTRACT

A polymer composition includes a block copolymer, at least one oligomeric solvent, and at least one solid additive. The block copolymer is mixed with the solvent and the solid additive at a temperature above 150° C. to form the polymer composition. The solid additive blooms to the surface of the polymer composition during the useable life of polymer composition, thereby decreasing the shelf-life and usable life of parts, such as golf club grips, created therefrom.

This application claims priority to U.S. Provisional Application No. 61/553,908 filed Oct. 31, 2011, titled Thermoplastic Polymer Compositions with Programmable End-of-Life and Method of Making the Same.

### FIELD OF INVENTION

This disclosure relates to thermoplastic polymer compositions and methods of making the same. Specifically, this disclosure relates to multi-component, physically cross-linkable thermoplastic polymers with an adjusted shelf-life and use-life.

### BACKGROUND

Thermoset polymer compositions may be used in the manufacture of grips for sporting goods and other plastic parts. These compositions may include thermal or UV curable rubber, silicones, and urethanes along with catalysts, hardeners, or vulcanizers. Once a thermoset polymer is chemically cross-linked, it permanently retains its structure and cannot be reprocessed or recycled. However, the chemical reactions that lead to cross-linking of thermoset polymers do not completely stop after the thermoset polymer is formed into a part, such as a grip. The continued, albeit slow, chemical cross-linking leads to ageing, long-term brittleness and lower shelf-life and use-life of the part.

Physically cross-linked thermoplastic polymer compositions, on the other hand, exhibit a greater reprocessability and recyclability than chemically cross-linked thermoset polymers. The processing time per part is greatly reduced when using physically cross-linked thermoplastic polymer compositions as there are no thermal or UV curing steps, which are usually slow processes, during the manufacture of the part. Additionally, no further cross-linking takes place after manufacture of the part, imparting it with long shelf-life and use-life. Manufactured parts made from physically cross-linked thermoplastic polymer compositions do not exhibit the eventual ageing, long-term brittleness, which in turn cause the part to fail and experience a lower shelf-life desired by many manufacturers.

### SUMMARY

It is an object of the present invention to provide a novel thermoplastic polymer composition and method of making the composition with predictable failure programmed therein that causes an additive to bloom to the surface over time, which causes the part to display qualities of failure, including without limitation brittleness, surface haze, or changes in tackiness, roughness or opacity. In one embodiment, a thermoplastic polymer composition with predictable failure programmed therein includes a block copolymer having a polymer matrix, at least one low volatility liquid aliphatic hydrocarbon solvent, an aliphatic resin having a glass transition temperature (Tg) near the temperature range of approximately 15° C. to 80° C. and a solid additive. The solid additive can be a thermal stabilizer, an ultraviolet stabilizer, an antioxidant or a phenolic stabilizer. The solid additive can be present in a concentration between approximately 0.1-1 wt % of the total composition. The solid additive is mixed with the block copolymer at a temperature above 150° C., and blooms to the surface of the block copolymer matrix during the useable life of the composition. As the additive accumulates on the surface, the quality of the surface diminishes. Thus, predictable failure is programmed into the polymer composition.

In another embodiment the thermoplastic polymer composition with predictable failure programmed therein includes at least two layers, where the first layer is in contact with the second layer. The first layer includes a first oligomeric solvent, a first solid additive having a first concentration, and a first block copolymer having at least one glassy polystyrene endblock and rubbery aliphatic midblocks. The second layer includes a second oligomeric solvent, and a second block copolymer. In this embodiment, a solid additive blooms to the surface of the first layer.

In an additional embodiment, a part with predictable failure programmed therein is made by mixing a block copolymer having at least one glassy polystyrene endblock and rubbery aliphatic midblocks with at least one solid additive. The solid additive comprises between 0.1% and 1 wt % of the total mixture. Additionally, the solid additive is selected from the group consisting of a thermal stabilizer, an ultraviolet stabilizer, an antioxidant and a phenolic stabilizer. A low volatility liquid aliphatic hydrocarbon solvent and a solid resin is added to the mixture. The resin has a glass transition temperature near the temperature range of approximately 15° C. to 80° C. The mixture is heated to a temperature greater than 150° C. The thermoplastic polymer composition is formed into a part. Over the course of the usable life of the part, the solid additive blooms to the surface of the part.

### BRIEF DESCRIPTION OF THE DRAWINGS

FIG. 1 is a schematic representation of a method of making a physically cross-linkable thermoplastic polymer composition and a part.

FIG. 2 is a schematic representation of a method of making a physically cross-linkable thermoplastic polymer composition.

FIG. 3 is a schematic representation of an embodiment of a method of making a part formed from a physically cross-linkable thermoplastic polymer composition.

FIG. 4 is a schematic representation of another embodiment of a method of making a extruded composition formed from a physically cross-linkable thermoplastic polymer composition.

FIG. 5 is an illustration of a part formed from two layers of a physically cross-linkable thermoplastic polymer composition.

### DETAILED DESCRIPTION

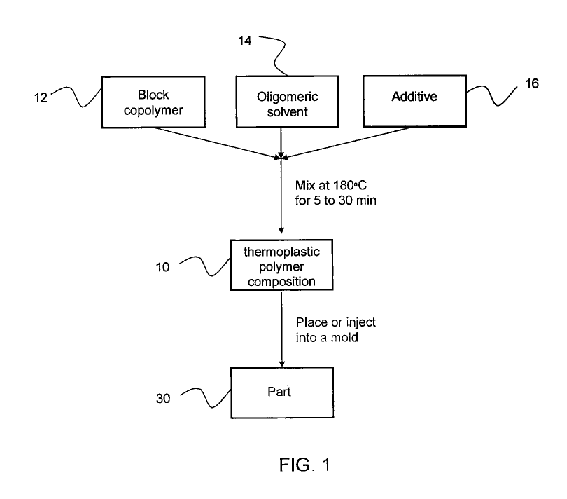

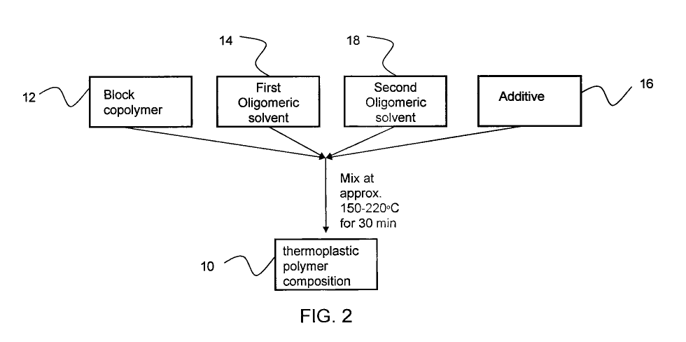

As shown in FIG. 1, a part 30, such as a grip for a golf club, may be made from a physically cross-linkable thermoplastic polymer composition 10 (herein after polymer composition 10). The polymer composition 10 may generally be made by combining a block copolymer 12 with at least one oligomeric solvent 14 and at least one solid additive 16. As shown in FIG. 2, the polymer composition 10 may also include a second oligomeric solvent 18.

The addition of the solid additive 16 to the polymer composition 10 imparts a predictable failure rate for the polymer composition 10 or the part 30 that is created from the composition. The failure rate may be determined or altered by selecting a solid additive 16 with appropriate solubility and diffusability properties that enable the solid additive 16 to bloom to the surface of the polymer composition 10 at a predetermined time. As the solid additive 16 accumulates on the surface of the polymer composition 10, the quality of the surface diminishes as the opacity and roughness increase, the level of tack decreases, and a haze-like film forms on the surface of the polymer composition 10—all of which cause the polymer composition 10 (or the part 30) to fail. Thus, predictable failure is programmed into the polymer composition 10. The failure mimics the failure that would occur due to the continuous chemical cross-linking in thermoset polymers, but maintains the recyclability and reprocessability of a physically cross-linked thermoplastic polymer. In addition, like a physically cross-linked thermoplastic polymer, the polymer composition 10 does not require thermal or UV curing, which reduces the processing time.

In one embodiment, referring again to FIG. 1, the block copolymer 12 is dissolved in the oligomeric solvent 14 to form a solution at a temperature above 150° C. so that the block copolymer 12 loses its cross-linking ability and displays low viscosity and good processability. The solution is then mixed with the solid additive 16. Generally, the mixing temperature may be within the range of about 150° C. to about 220° C., and in one embodiment may be about 180° C.

The block copolymer 12, oligomeric solvent 14, and the solid additive 16 may be mixed at the elevated temperature for about 30 minutes or more, for batch operations, in order to form the polymer composition 10. The mixing time may be between 3 to 8 minutes or between 5 to 8 minutes for continuous processing operations. As the polymer composition 10 cools to a temperature below 150° C., it becomes more solid-like with higher modulus and elasticity as physical cross-links form at the lower temperatures.

Once the polymer composition 10 is formed or extruded, it may be molded, or formed into part 30. Over time, the solid additive 16 within part 30 will bloom to its surface, causing the part 30 to fail.

In one embodiment, the block copolymer 12 may be an ABA triblock copolymer. A and B represent blocks of homopolymer subunits, arranged along the polymer chain in the following sequence, (A)-(B)-(A). The ABA triblock copolymer may include glassy polystyrene endblocks and rubbery aliphatic midblocks. The rubbery aliphatic midblocks may include poly(ethylene-co-butylene). Suitable block copolymers 12 may include poly(styrene-ethylene-co-butylene-styrene) or poly(styrene-isoprene/butadiene-styrene), however, other suitable midblocks and endblocks may be used.

The block copolymer 12 may include between 15-65 wt % polystyrene. In another embodiment, the block copolymer 12 may include between 30-35 wt % polystyrene. Suitable block copolymers 12 may also include semi-crystalline-(rubbery)-semi-crystalline triblock copolymers, such as poly(styrene-ethylene/butylene-styrene) (“SEBS’), poly[styrene-(ethylene-alt-propylene)-styrene] (“SEPS”), poly(styrene-[ethylene-(ethylene-propylene)]-styrene) (“SEEPS”), poly(styrene-butadiene-styrene) (“SBS”), poly(styrene-isoprene-styrene) (“SIS”), or poly(styrene-isoprene/butadiene-styrene) (“SIBS”).

In another embodiment, the block copolymer 12 may be a polyethylene-polyethylenepropylene-polyethylene triblock copolymer or a polymethyl methacrylate based triblock copolymer. One example of another suitable block copolymer 12 is a poly(methyl methacrylate)-b-poly(t-butyl acrylate)-poly(methyl methacrylate) (“PMMA-PtBA-PMMA”) triblock copolymer. However, other polymethyl methacrylate based triblock copolymers may be used.

In another embodiment, the block copolymer 12 may be a triblock copolymer having the repeat structure ABC. A, B and C represent blocks of homopolymer subunits, arranged along the polymer chain in the following sequence, (A)-(B)-(C). In yet another embodiment the block copolymer 12 is a multiblock copolymer and has a number of homopolymer subunits, arranged along the polymer chain that is smaller or larger than a triblock copolymer. Table 1 details non-limiting examples of block copolymers 12 that may be used in polymer composition 10.

TABLE 1

| | | | | Number average |
|---|---|---|---|---|
| Block | | | Polystyrene | molecular weight |
| Copolymer | Grade | Manufacturer | (wt %) | (Mn) in (kg/mol) |
| SEBS No. 1 | G1650 | Kraton | 30 | 95 |
| SEBS No. 2 | G1651 | Kraton | 33 | 267 |
| SEBS No. 3 | G1654 | Kraton | 31 | 144 |
| SEBS No. 4 | G1660 | Kraton | 30 | 72 |
| SEBS No. 5 | G1652 | Kraton | 30 | 56 |
| SEPS | S2006 | Kuraray | 35 | 300 |
| SEP | G1701 | Kraton | 37 | 110 |
| EP* | 3200A | DSM | 0 | 76 |

*49% ethylene

Referring again to FIG. 1, the polymer composition 10 also includes at least one oligomeric solvent 14. The oligomeric solvent 14 can be an aliphatic hydrocarbon, including for example, aliphatic mineral oils, naphthenic oils, aromatic oils, animal oils, or plant oils. In one embodiment the oligomeric solvent 14 is Hydrobrite 380.

Referring to FIG. 2, the polymer composition 10 may further include a second oligomeric solvent 18. The first oligomeric solvent 14 may be a solid and the second oligomeric solvent 18 may be a liquid. The first oligomeric solvent 14 may be an aliphatic resin with a glass transition temperature (Tg) near room temperature, about 15° C. to 75° C., and the second oligomeric solvent 18 may be a low volatility liquid aliphatic hydrocarbon solvent.

The oligomeric solvent(s) 14 and 18 may be mixed with or used to dissolve the block copolymers 12 described in Table 1. The oligomeric solvents 14 and 18 may be a tackifier resin and an oil, respectively. The tackifier resin can include aliphatic resins, cyclo-aliphatic resins, cycloaliphatic/aromatic resins, rosin esters, or bitumen derived resins. In one embodiment a hydrocarbon tackifier resin, Escorez 5380 manufactured by ExxonMobil, is used as the first oligomeric solvent 14. Table 2 details non-limiting examples of the properties of tackifier resins which may be used as the first oligomeric solvent 14.

TABLE 2

| Code | Grade | Manufacturer | Tg (° C.) | Mn (gm/mol) |
|---|---|---|---|---|
| R1 | 5380 | ExxonMobil | 30 | 190 |
| R2 | 5300 | ExxonMobil | 48 | 210 |
| R3 | 5340 | ExxonMobil | 74 | 230 |
| R4 | 1304 | ExxonMobil | 53 | 750 |

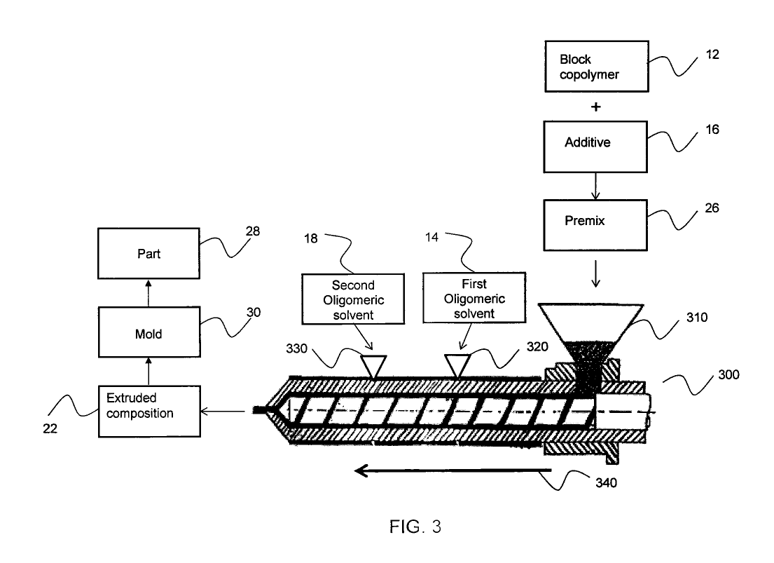

As discussed above, the block polymer 12 may first be mixed with the first oligomeric solvent 14 and/or the second oligomeric solvent 18 to form a solution that may then be mixed with the solid additive 16 at a mixing temperature of between 150 to 220° C. Alternatively, the solid additive 16 and the block polymer 12 may be combined to form a premix 26 (as shown in FIG. 3). The premix 26 may then be combined with the first oligomeric solvent 14 and/or the second oligomeric solvent 18, at a mixing temperature of between 150 to 220° C., to form the polymer composition 10.

The solid additive 16 may be insoluble in the oligomeric solvent(s) 14 and 18 or supersaturated. In one embodiment, the solid additive 16 may be a thermal stabilizer, an ultraviolet stabilizer, an antioxidant, or a phenolic stabilizer. In another embodiment, the solid additive 16 may be any other additive that is insoluble in the solvent, e.g., a supersaturated molecule. The solid additive 16 can be between 0.1% and 1 wt % of the total weight of the polymer composition 10. In an alternative embodiment, the solid additive 16 can be between 0.1% and 0.5 wt % of the total weight of the polymer composition 10.

In another embodiment the solid additive 16 may be a phenolic stabilizer, such as a hindered phenolic antioxidant, organophosphite stabilizer, or a blend thereof. Examples of commercially available phenolic stabilizers include Irganox, Irgafos, and blends thereof (manufactured by BASF). In one embodiment, the antioxidant Irganox B220 may be used as a stabilizer during mixing in an extruder. However, other blends and grades of antioxidants may be used in the polymer composition 10.

Notably, the solubility of these antioxidants in the polymer composition 10 does not follow simple thermodynamic rules (Flory-Huggins solution theory) because of self-association and the effect of thermal history. However, generally speaking, phenolic antioxidants with a smaller heat of fusion (lower melting point) tend to have higher solubility in the polymer composition 10.

In one embodiment, the additive 16 may be polar. Because the block copolymer 12 and the oligomeric solvents 14 and 18 are usually non-polar, the enthalpy of mixing will disfavor solubility of the solid additive 16 with the block copolymer 12 and solvent(s) 14 and 18. Therefore, mixing the solid additive 16 with the block copolymer 12 and solvent(s) 14 and 18 at an elevated temperature or between about 150° C. to about 220° C. increases the solubility of the solid additive 16 and encourages mixing. While elevated mixing temperatures may be used, between about 150° C. to about 220° C., lower mixing temperatures can also be used so long as the solid additive 16 can be thoroughly mixed with the block copolymer 12 and the oligomeric solvents 14 and 18.

Only when the polymer composition 10 is cooled below 150° C. and begins to solidify does the incompatibility and insolubility of the solid additive 16 manifest. Gradual phase separation between the block copolymer 12 and the solid additive 16 may occur. If the diffusion rate of the solid additive 16 is high enough, the solid additive 16 will migrate to the surface of the polymer matrix.

Parameters affecting the rate of solid additive 16 bloom include the solubility and diffusability of the solid additive 16 in the polymer composition 10. This, in turn, depends on the properties of the solid additive 16, like shape, size, chemical nature, hydrogen bonding, and thermal history. Bloom rate may also depend on extrinsic parameters like the concentration of the solid additive 16, temperature, humidity of the environment, and the properties of the block copolymer/solvent mixture.

As shown in FIG. 3, the polymer composition may be made using an extruder 300. The mixing process can be accomplished using any continuous, stepwise, or batch process known to one skilled in the art. One method of processing such a composition is to combine the block copolymer 12 and the solid additive 16 to form a premix 26. The premix 26 is then added to the extruder feed 310. Alternatively, the block copolymer 12 with and a solid additive 16 can be added to the feed 310 separately. A first solid oligomeric solvent 14 can be added at an inlet 320. A second oligomeric solvent 18 can be added to an inlet 330. Optionally, only one oligomeric solvent may be used. The processing temperature can be about 150° C. to about 220° C. Specifically, the mixing temperature may be about 180° C. Additionally, the temperature may increase as the mixture travels along the flow direction 340 in the extruder 300 to form an extruded composition 22. The processing time of the extrusion may be approximately 3 to 8 minutes. The processing time may be approximately 5 minutes. The block copolymer 12, solid additive 16, first oligomeric solvent 14, and second oligomeric solvent 18 may be mixed in various ratios and in various sequences to yield different physical properties of the extruded composition 22.

The resulting extruded composition 22 may then be further processed by suitable fabrication techniques to form a wide variety of plastic parts. One such technique may be using an injection molding machine to form the final part.

### EXAMPLES

A premix of an antioxidant and SEBS were added to an extruder with a processing temperature of 180° C. The processing temperature was increased by approximately, 20 to 40° C. as the premix traveled from the extruder feed in the flow direction. During processing a tackifier resin, namely Escorez 5380 manufactured by ExxonMobil was added to the extruder to form a mixture. Later in the extrusion process, as the mixture flowed toward the outlet, a liquid solvent, such as oil, was added to the extruder to form a cosolvent mixture. Finally, the temperature of the mixture was decreased below 180° C. upon exiting the extruder and entering a cavity. After processing was complete, the Young's Modulus was measured for the resulting compositions.

Table 3 details the modulus of elasticity of various polymer compositions after processing according to the example above. All of the polymer compositions measured, exhibited an acceptable modulus of elasticity. Thus, the mechanical properties of the polymer compositions were not adversely effected by the addition of the solid additive, in this example, the antioxidant. Depending upon the type of mold used and the type of part desired, a modulus of between 2-3 MPa (megapascals) may be desirable. However, a composition with a lower modulus may be used for other molds and other types of parts.

In the examples in Table 3, the weight percentage of the SEBS varied from 20 wt % to 70 wt % , with the remainder of the polymer composition comprising 29 wt % to 79 wt % of the solid resin/resin oil cosolvent mixture and 0.1 wt % to 1 wt % antioxidant. In an alternative embodiment, the antioxidant can be between 0.1% and 0.5 wt % of the polymer composition.

TABLE 3

| | | Wt % of block copolymer in the system | | | | | | | | | | |
|---|---|---|---|---|---|---|---|---|---|---|---|---|
| | | 20 | 25 | 30 | 35 | 40 | 45 | 50 | 55 | 60 | 65 | 70 |
| Ratio | 0 | 0.27 | 0.38 | 0.45 | 0.70 | 0.85 | 1.12 | 1.54 | 2.00 | 2.65 | 3.00 | 3.43 |
| Solid | 0.2 | 0.27 | 0.35 | 0.46 | 0.80 | 0.81 | 1.25 | 1.52 | 2.35 | 2.75 | | |
| Resin/ | 0.4 | 0.29 | 0.43 | 0.45 | 0.71 | 0.95 | 1.11 | 1.50 | 2.13 | 2.98 | 3.27 | 3.35 |
| resin | 0.6 | 0.37 | 0.44 | 0.52 | 0.72 | 1.09 | 1.28 | 1.90 | 2.27 | 2.81 | | |
| oil | 0.8 | 0.33 | 0.60 | 0.61 | 0.78 | 1.10 | 1.42 | 1.87 | 2.35 | 2.95 | 3.40 | 3.78 |
| | 0.9 | 0.68 | 0.70 | 0.67 | 0.84 | 1.04 | 1.57 | 2.26 | 2.55 | 2.90 | | |
| | 0.95 | 1.60 | 1.26 | 0.95 | 0.88 | 1.28 | 1.59 | 2.15 | 2.75 | 3.02 | | |
| | 1 | 5.25 | 3.54 | 1.83 | 1.57 | 1.38 | 1.78 | 2.68 | 2.98 | 3.21 | 3.41 | 3.68 |

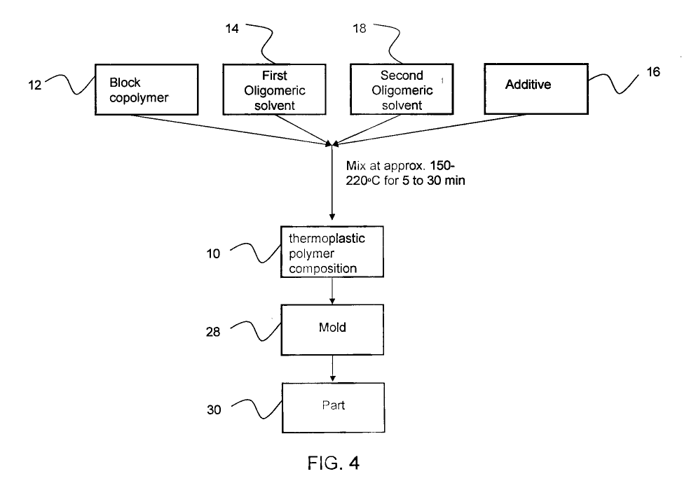

As shown in FIG. 4, the method of making a part 30, such as a golf grip, includes mixing a block copolymer 12, at least one oligomeric solvent 14, and at least one solid additive 16. The solid additive 16 may be mixed with the block copolymer 12 and the at least one oligomeric solvent 14 at an elevated temperature between about 150° C. to about 220° C. to form a polymer composition 10. Specifically, the mixing temperature may be about 180° C. The polymer composition 10 is then placed in a mold 28 that shapes the polymer composition 10 into part 30. At some predetermined time, the solid additive 16 will bloom to the surface of the part 30, thereby changing its properties, as described above, shortening the usable life of the part.

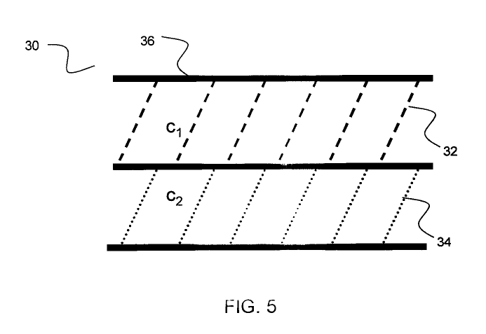

As shown in FIG. 5, a part 30 may contain at least two layers 32 and 34. The first layer 32 may include a first triblock copolymer 12, at least one first oligomeric solvent 14, and a first solid additive 16 having a concentration c1. The second layer 34 may include a second triblock copolymer 12′ and a second oligomeric solvent 14′. The second layer 34 may optionally have a second solid additive 16′ having a concentration c2. The concentrations c1 and c2 are the weight percentage of the respective solid additives in the polymer compositions. The first layer 32 may be in contact with the second layer 34. At some predetermined time, the first solid additive 16, the second solid additive 16′, and/or both will bloom to the surface 36 of part 30, thereby changing the properties of the part 30, as described above, shortening the usable life of the part 30.

While the disclosure has been illustrated by the description of embodiments thereof, and while the embodiments have been described in considerable detail, it is not intended to restrict or in any way limit the scope of the appended claims to such detail. Additional advantages and modifications will readily appear to those skilled in the art. Therefore, the disclosure, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A polymer composition with predictable failure programmed therein comprises:
a triblock copolymer;
a low volatility liquid aliphatic hydrocarbon solvent;
an aliphatic resin solvent having a glass transition temperature within the range of approximately 15° C. to 80° C.; and
at least one solid additive selected from the group comprising a thermal stabilizer, an ultraviolet stabilizer, an antioxidant and a phenolic stabilizer,
wherein the at least one solid additive is present in a concentration between approximately 0.1-1 wt % of the total weight of the polymer composition, and
wherein the liquid aliphatic hydrocarbon solvent is mixed with the triblock copolymer at a temperature above approximately 150° C.

2. The polymer composition of claim 1, wherein the triblock copolymer comprises between approximately 15-65 wt % polystyrene and has an ABA or ABC repeat structure with at least one glassy polystyrene endblock and at least one rubbery aliphatic midblock.

3. The polymer composition of claim 2, wherein the triblock copolymer is selected from the group consisting of SEBS, SEPS, SEEPS, SBS, SIS, and SIBS.

4. The polymer composition of claim 3 wherein the solid additive comprises a mixture of a hindered phenolic antioxidant and an organophosphite stabilizer.

5. The polymer composition of claim 1, wherein the triblock copolymer comprises a PMMA-PtBA-PMMA triblock copolymer.

6. The polymer composition of claim 1, wherein the triblock copolymer comprises a polyethylene-polyethylenepropylene-polyethylene triblock copolymer.

7. The polymer composition of claim 1, wherein the triblock copolymer is a polymethyl methacrylate based triblock copolymer.

8. A composition of matter with predictable failure programmed therein comprising:
a first layer comprising a first oligomeric solvent, a first triblock copolymer having at least one glassy polystyrene endblock and at least one rubbery aliphatic midblock, and a first solid additive having a first concentration, wherein the first solid additive is selected from the group consisting of a thermal stabilizer, an ultraviolet stabilizer, an antioxidant, and a phenolic stabilizer; and
second layer in contact with the first layer, the second layer comprising a second oligomeric solvent and a second triblock copolymer.

9. The composition of claim 8, wherein the first triblock copolymer comprises between approximately 15-65 wt % polystyrene.

10. The composition of claim 9, wherein the first oligomeric solvent is a low volatility liquid aliphatic hydrocarbon solvent and the second oligomeric solvent is an aliphatic resin with a glass transition temperature within the range of approximately 15° C. to 75° C.

11. The composition of claim 8, wherein the first triblock copolymer is selected from the group consisting of SEBS, SEPS, SEEPS, SBS, SIS, and SIBS.

12. The composition of claim 8, wherein the second triblock copolymer is a polymethyl methacrylate based triblock copolymer.

13. The composition of claim 8, wherein the first solid additive comprises a mixture of a hindered phenolic antioxidant and an organophosphite stabilizer.

14. The composition of claim 8, wherein the second layer further comprises a second solid additive having a second concentration.

15. The composition of claim 14, wherein the first concentration is different than the second concentration and wherein the first concentration is between approximately 0.1-0.5 wt % of the total weight of the polymer composition.

16. The composition of claim 8, wherein the first concentration is between approximately 0.1-1 wt % of the total weight of the polymer composition.

17. The composition of claim 8, wherein the first solid additive is a supersaturated molecule that is insoluble in the first oligomeric solvent.

18. A method of making a part from a polymer composition with predictable failure programmed therein comprising:
mixing a block copolymer having at least one glassy polystyrene endblock and at least one rubbery aliphatic midblock with at least one solid additive to form a premix,
wherein the at least one solid additive comprises between 0.1% and 1 wt % of the total weight of a polymer composition, and wherein the at least one solid additive is selected from the group consisting of a thermal stabilizer, an ultraviolet stabilizer, an antioxidant and a phenolic stabilizer;
adding a low volatility liquid aliphatic hydrocarbon solvent and a solid resin solvent having a glass transition temperature within the range of approximately 15° C. to 80° C. to the premix to form a mixture;
heating the mixture to a temperature of at least about 150° C. to form the polymer composition; and
forming the polymer composition into a part.

19. The method of claim 18, wherein the low volatility liquid aliphatic hydrocarbon solvent is selected from the group consisting of an aliphatic mineral oil, a naphthenic aromatic oil, an animal oil, and a plant oil.

20. The method of claim 18, wherein the solid resin solvent is selected from the group consisting of an aliphatic resins, a cyclo-aliphatic resins, a cycloaliphatic/aromatic resins, a rosin ester, and a bitumen derived resin.
